(19) United States
(12) Patent Application Publication
(10) Pub. No.: US 2009/0187764 A1
(43) Pub. Date: Jul. 23, 2009

(54) ELECTRONIC CERTIFICATION, IDENTIFICATION AND COMMUNICATION UTILIZING ENCRYPTED GRAPHICAL IMAGES

(75) Inventors: Pavel Astakhov, Moscow (RU); Roman Tankelevich, Lakewood, CO (US); Anton Klimov, Moscow (RU)

Correspondence Address: Jason H. Vick;Sheridan Ross, PC, Suite # 1200, 1560 Broadway, Denver, CO, 80202, US

(73) Assignee: Pavel Astakhov, Moscow (RU)

(21) Appl. No.: 12/194,270

(22) Filed: Aug. 19, 2008

Related U.S. Application Data
(60) Provisional application No. 61/021,919, filed on Jan. 18, 2008.

(51) Int. Cl. H04L 9/32; H04L 9/28

(52) U.S. Cl. 713/170; 713/175

(57) ABSTRACT

A system and method for electronic certification, identification and communication. According to an exemplary implementation, these processes are performed by using an electronic graphic image with encrypted information concerning the certified object. The object is accompanied with an application specific image hereafter called Electronic Virtual Stamp (EV-Stamp) having embedded and encrypted control information (keys and electronic signatures, identifiers of senders and receivers, date and other transaction related information) as well as any message to be passed. Each transaction of the EV-Stamp is monitored by a specialized Web server that maintains the records of all issued electronic stamps, all subscribed users, all involved financial transactions, and all registered assets. It is also possible to use any other graphical images to reflect on various possible applications such as exchange of the EV-Stamp for a good/service.

### RELATED APPLICATION DATA

This application claims the benefit of and priority under 35 U.S.C. §119(e) to U.S. provisional Patent Application No. 61/021,919, filed Jan. 18, 2008, entitled “System and Method for Electronic Certification, Identification and Communication by Using Encrypted Graphic Images,” which is incorporated herein by reference in its entirety.

### FIELD OF THE INVENTION

An exemplary embodiment of the invention relates to communication and one or more electronic stamps.

More specifically, an exemplary embodiment of the present invention relates generally to sending electronic messages (digital information) such as electronic messages, electronic mail, chat messages, pay orders, images, business documents, and in general any information, using Internet related means to certify messages, to identify senders and receivers and to guarantee the secure and protected passage of information intended to communicate between individual users, as well as between an individual user and Web sites open to publicly traded information, electronic services (consulting, financial and others), buying and selling goods, collecting artifacts and other objects, auctioning, and such.

Secondly, an exemplary embodiment of the present invention relates to the methods of encryption of information embedded inside graphic images.

Another exemplary embodiment relates to traditional postal services using electronic stamping technology.

### BACKGROUND

Electronic communication via emails and web services is a common practice, in business activities and the individual's day-to-day life. Considerable effort has been dedicated to improving and enhancing the means used in such practices, such as:
Certification of messages and other forms of information
Image Cryptography
Electronic post stamping
Electronic payment systems.

### SUMMARY

1. Certification of Messages

Messages sent via Internet are not secure and fully protected due to the very nature of Internet protocols and methods of communication. Numerous methods, systems and software tools have been developed and implemented to assure reliable and secure communication via the Internet. Most recently, the following developments have been discussed and/or implemented in this field.

1.1. A thawte Personal E-mail Certificate in conjunction with the thawte Web of Trust allows the user to secure and guarantee authorship of e-mail communications by digitally signing and encrypting e-mails. The system is open to the public and easy to use. A thawte Personal E-mail Certificate can be used indefinitely. The user must enroll, however, to obtain certificates. The membership in the system is essential for reliable functioning of the system. The existing members of a so called Web of Trust can become notaries who should certify the identity of other personal certificate users belonging to the membership.

1.2. America Online® and Yahoo®, two of the world's largest providers of e-mail accounts, are about to start using a system that gives preferential treatment to messages from companies that pay from ¼ of a cent to a penny each to have them delivered. The senders must promise to contact only people who have agreed to receive their messages, or risk being blocked entirely. The Internet companies say that this will help them identify legitimate mail and cut down on junk e-mail, identity-theft scams and other scourges that plague users of their services. (They also stand to earn millions of dollars a year from the system if it is widely adopted!). AOL® and Yahoo® will still accept e-mail from senders who have not paid, but the paid messages will be given special treatment. On AOL®, for example, they will go straight to users' main mailboxes, and will not have to pass the spam filters that could divert them to a junk-mail folder or strip them of images and Web links. As is the case now, mail arriving from addresses that users have added to their AOL® address books will not be treated as spam. Yahoo® and AOL® say the new system is a way to restore some order to e-mail, which, because of spam and worries about online scams, has become an increasingly unreliable way for companies to reach their customers, even as online transactions are becoming a crucial part of their businesses. It was pointed out that the postal service has a very similar system to provide different options such as certified mail. In a broader sense, the move to create what is essentially a preferred class of e-mail is a major change in the economics of the Internet. Until now, senders and recipients of e-mail—and, for that matter, Web pages and other information—each covered their own costs of using the network, with no money changing hands. That model is different from, say, the telephone system, in which the company whose customer places a call pays a fee to the company whose customer receives it. The prospect of a multi-tiered Internet has received a lot of attention recently after executives of several large telecommunications companies suggested that they should be paid not only by the subscribers to their Internet services but also by companies that send large files to those subscribers, including music and video clips. Those files would then be given priority over other data, a change from the Internet's basic architecture which treats all data in the same way. But critics of the plan say that the two companies risk alienating both their users and the companies that send e-mail. The system will apply not only to mass mailings but also to individual commercial messages like order confirmations from online stores and customized low-fare notices from airlines.

1.3. A more troublesome problem now is phishing, messages that appear to be from a bank or an online payment service and seek to fool recipients into divulging their passwords or credit card numbers. Phishing has led Internet providers and other companies to look for ways to help people identify legitimate mail. A company called Goodmail™ (http://www.goodmailsystems.com/) has carried out the idea that it would charge postage for all mail, but, eventually, it has narrowed its focus to mail sent by companies and major nonprofit organizations, which will pay a reduced rate. Messages from paying customers will bear a special symbol to indicate that they are not fraudulent. There is a consensus among the experts that an e-mail in-box is a potentially dangerous place and, therefore, there is a tremendous need for a class of certified e-mail that can convey to consumers that a message is authentic. Experts also believe that companies will be glad to pay the postage fee because their customers will have more trust in their e-mail and thus will buy more from them.

2. Image Cryptography

Else of images to send encrypted messages is a very popular idea implemented in different practical systems.

2.1. Image Cryptography allows one to hide messages within image files. New image files do not change in appearance so encrypted messages are undetectable. Encrypting messages takes a few easy steps: (a) Select the image file; (b) Type a password to protect the message; (c) Type the message to encrypt; (d) Call Encrypt Data function.

The user then is provided with an additional validation code to be used later in conjunction with the password to extract the hidden data. Extracting the hidden data takes the following steps: (a) Select the image file with encrypted message; (b) Type in the password; (c) Type in the validation code; (d) Call Decrypt Image function. The decrypted data is presented on the screen and then can be copied to the clipboard or saved to a file.

2.2. AsMask 2.6 by AsMask can encrypt and hide many formats of secret files or text messages into an image, such as Microsoft® Word, Excel®, PowerPoint® documents, pdf's, movies, audio files, etc.

2.3. I-Cipher AP 2.2.2 by AMBITWARE is an image file encryptor/decryptor with a build-in activity log to record every action. I-Cipher can process various image file formats. Encrypted images are saved as bitmap files to preserve high image quality.

2.4. Tipi (Text-In-Picture) prepares innocent looking e-mails with hidden message or files where the message is hidden in attached pictures. One can also hide information in an ordinary picture. Tipi can store passwords, or any confidential data in that file, and can be used to send secret messages, embedded in official or monitored e-mail. The message can be protected by a password and encrypted by a strong encryption algorithm. Encrypted information stored by Tipi in files looks like any ordinary picture that can be stored in an insecure place or sent over insecure medium, like public e-mail service. Pictures modified by Tipi can be viewed by any image viewer but only Tipi can show the hidden text.

3. Electronic Post Stamping

Electronic processing of postage is gaining popularity with the purpose to improve and secure the traditional postal (non-electronic) service.

3.1. Electronic Stamping technology, STAMPIT, was developed in Germany in 2001. It revolves around a number of key components in the system:

A rechargeable electronic wallet that lets customers pay for the stamping service;

A Postage Point central server that registers all electronic signatures generated and stores securely the keys needed to authenticate the customers; and

A checking point at the sorting office that is capable of verifying automatically the electronic signatures generated by the customers that are encoded on the electronic stamp and printed on an envelope.

In the STAMPIT system, the following succession of events takes place:

1. On the customer PC, the Electronic Wallet is “charged” with the correct amount of money to pay for the stamp. If not, the customer can re-charge his wallet online from the Internet site of STAMPIT.

2. The STAMPIT software generates the electronic stamp, which is directly printed on the envelope with the address using a simple inkjet or laser printer.

3. The letter is posted in a normal way.

4. The letter is received at the local sorting center.

5. The letter sorting center automatically reads the electronic stamp and is capable of verifying the validity of the stamp, communicating with the postage point server to retrieve the validation information.

This complicated automated system needs security throughout in order to guarantee that none of the data (registration, payment, signature, e-Stamps, and verification keys) can be compromised during the lifecycle of each electronic stamp. In the STAMPIT infrastructure, in order to guarantee the security of the users, a large number of cryptographic operations are performed each time an end-user creates a digital stamp. These operations include the generation of the stamp, the secure storage of the customer and stamping information and the passing of cryptographic information between the different elements of the architecture. Throughout the STAMPIT infrastructure, WebSentry™ products are used to provide the vital security around all these cryptographic operations. The WebSentry™ products serve as secure storage units for cryptographic keys, which provide the guarantee that the keys cannot be compromised. More importantly, they are also used as critical key management elements which allow for all the components of the system to exchange information in total security. Finally, the WebSentry™ products act as cryptographic accelerators and guarantee that the security operations of the STAMPIT system can run 24 hours a day and 7 days a week with optimized performance.

3.2. Since its inception, the idea of secure postage was tested not only in Germany but in Great Britain as well. Electronic postage stamps, stamps one can print directly onto envelopes from one's printer, can also be prone to a number of significant errors and faulty functions. Usually, a user registers with the system such as STAMPIT and then can buy a type of virtual stamp in the form of smart PDFs. When the stamp is printed from the user's computer system the PDF contacts the Post Office server to check if it is still valid. It does this without the user registering—it is just the stamp itself “phoning home”. In this transaction, the unique identifier of the stamp is cancelled on the server so that no further printings of that stamp can be made. Many users reported serious problems concerning the situations when the printer jams, or when multiple copies are printed instead of just one. It is relatively easy to produce multiple copies of any individual stamp, by the “normal pdf” method or even by photocopying, but it is the use of the stamp that matters. As the stamp contains unique information and is read when the stamp passes into the post office system, this is the check to prevent abuse.

The UK SmartStamp system seems to be better considered. When the equivalent “phone home” process takes place it does so under the control of its own software that has been installed on the user's PC after registration. The UK security system is intended to prevent the client using a stamp more than once, whilst the German system is aimed at preventing the client from even trying to print it more than once—and in the process it can provide users with totally unnecessary problems.

4. Electronic Payment Systems

Most money in today's world is electronic, and the use of tangible cash is becoming less frequent. With the introduction of internet and online banking, debit cards, online bill payments and internet business, paper money is becoming a thing of the past. Banks now offer many services whereby a customer can transfer funds, purchase stocks, contribute to their retirement plans (such as Canadian RRSP) and offer a variety of other services without having to handle physical cash or checks. Customers do not have to wait in lines; this provides a lower-hassle environment. Debit cards and online bill payments allow immediate transfer of funds from an individual's personal account to a business's account without any actual paper transfer of money. This offers a great convenience to many people and businesses alike. The main focuses of digital cash development are 1) being able to use it through a wider range of hardware such as secured credit cards; and 2) linked bank accounts that would generally be used over an internet means, for exchange with a secure micropayment such as in large corporations (e.g., PayPal®). Furthering network evolution in terms of the use of digital cash, a company named DigiCash® is at the focus of creating an e-cash system that would allow issuers to sell electronic coins at some value. When they are purchased they come under someone's own name and are stored on his computer or under an online identity. At all times, the e-cash is linked to the e-cash company and all transactions go through it, so the e-cash company secures anything that is purchased. Only the company knows your information and will properly direct purchases to your location. Theoretical developments in the area of decentralized money are underway that may rival traditional, centralized money. Systems of accounting such as Altruistic Economics are emerging that are entirely electronic, and can be more efficient and more realistic because they do not assume a zero-sum transaction model.

In accordance with an exemplary embodiment, an electronic virtual stamp can be used to certify virtual payments, to provide encrypted images of checks, bill pay orders and other financial instruments going beyond the scope of the existing forms of electronic monies. The same system can be used to create an electronic banknote. This will embed the payment with encryption in the graphic image of a banknote or other financial instrument(s). It will be an enhancement of such Patent Applications as the following one:

Electronic payment method and related system and devices (United States Patent Publication 20070219902)

The invention in 20070219902 proposes an electronic payment method through a telecommunication network, the payment relating to a service provided to a buying entity by a selling entity. According to the method, an amount corresponding to the service is debited from an account of the buying entity. At least first and second information elements representing respective parts of a paying means corresponding to said amount are received, at the buying entity, both first and second information elements being required to get paid of said amount. The first information element is transmitted to the selling entity. The buying entity is provided with said service. And the second information element is conditionally transmitted to the selling entity.

An exemplary proposed method of the present invention presents the technology to deal at least with the issues above in a single integrated way. One exemplary approach is based on using encrypted images while exchanging messages. The method can be embodied in various forms such as:
1. an electronic equivalent of postal services using electronic stamps;
2. electronic finance and Internet payment systems;
3. business letterheads, stamped papers and other official paperwork;
4. official certificates of all kinds; and
5. in general, utilization of encrypted information in conjunction with one or more types of information such as a document.

All these technological embodiments have a common client-server architecture implemented in conjunction with an Internet site(s).

One exemplary embodiment utilizes secure communication, image cryptography, and electronic financial and other services.

One exemplary method is accompanied with a characteristic GUI (graphic user interface) and a collection of electronic postage stamps and other graphic images.

In accordance with another exemplary embodiment of the proposed method, the communication's security is supported by using a special, easily recognizable, image (an Electronic Virtual stamp—“EV-Stamp”), that is attached to, associated with or otherwise part of, an emailed message. An authoritative server, or network of servers, is used to issue and manage such security certificates (EV-Stamps) having a form of encrypted images associated therewith.

In one proposed method, the EV-Stamp is also an encrypted image but it is part of the integrated system that supports communication among users of the same network of servers. Thus, the encryption can be absolutely transparent to the users.

In another proposed method, a stamp is electronic and virtual. No printing is necessary. While the method of EV-Stamp's functioning is different and much broader concerning all forms of electronic communications utilizing encrypted images, the exemplary system uses a central server(s) that registers all electronic signatures generated and stores securely the keys needed to authenticate the customers and the EV-Stamps.

The exemplary method presents technological solutions to address the issues above in a single integrated way. The approach is based on using encrypted images while exchanging the messages. The method can be embodied in various forms such as:

(1) an electronic equivalent of postal services using electronic virtual stamps;

(2) electronic finance and Internet payment systems;

(3) business letterheads, stamped papers and other official paperwork;

(4) official certificates of all kinds.

All these technological embodiments have a common client-server architecture implemented as an Internet service using EV-Stamp Server(s).

The exemplary method utilizes both existing and specially developed technologies of secure communication, image cryptography, and electronic financial and other services.

The method is accompanied with a characteristic GUI (graphic user interface) and a collection of electronic postage stamps and other graphic images.

Hereinafter, the proposed method is called the Electronic Virtual Stamp, or “EV-Stamp.” Although it is considered to be, first and foremost, an electronic analogue of a postal stamp, it can be used in many other graphical forms.

One of the main exemplary advantages of the proposed method is the use of easily recognizable and familiar images. Thus, the created images have the potential to also become a collector's items and be accepted by philatelic (stamp-collectors) and other collector society(ies).

1. EV-Stamp

An exemplary EV-Stamp is embedded in an electronic message graphical certificate of authenticity, functionality and associated value. The EV-Stamp can carry a visual image representing, for example, the value, purpose and/or functionality of a transferred message. However, in general, the EV-Stamp can include any graphical image(s), multimedia content, hidden content, and the like, and the various types of content need not be viewable by the human eye.

As an example, a user can send an email with an EV-Stamp with a specified value to another user to certify to the receiver that this mail is valid (not spam). In other cases, a user can perform a financial transaction with another user by sending an EV-Stamp having a specified redeemable value.

One exemplary embodiment of the EV-Stamp comprises three components:

(1) Graphical/Multimedia image(s). The EV-Stamp is created, stored and distributed by an EV-Stamp Internet, email server or other distribution mechanism. The EV-Stamp can include an image(s) that can resemble traditional post stamps. In some cases, the images can be of official seals, offset prints, stationary, financial forms as well as elements of different typesets. The images can also be based on user designs or artistic works in themselves. They could also include portions of photographs, and have indicia (postmarks) similar to paper money or paper stamps. Also, the images or other graphical content can represent an underlying functionality associated with the EV-Stamp as discussed hereinafter.

(2) Control Information (CI). Control Information includes the ID of the EV-Stamp and information about the message sent with the EV-Stamp. The latter comprises one or more of the Sender ID, the Receiver ID and the encrypted message's digest and electronic signature. This allows one to test the integrity of the message upon its receipt by the Receiver. Control Information can also include any other message(s) that specify the EV-Stamp's functionality, value, etc. Control Information is encrypted and embedded into or otherwise associated with the EV-Stamp, such as within the image of the EV-Stamp. The encryption can be based on mixing the pixels with CI and/or using tags attached to or otherwise associated with the image. Indicia (a postmark) can be optionally imprinted on the EV-Stamp every time a transaction occurs. The indicia could also take the form of encrypted information associated with the EV-Stamp.

(3) Records in the EV-Stamp server. Every issued EV-Stamp has a corresponding record in the EV-Stamp server. It reflects all transactions associated with the EV-Stamp. Thus, the server has the current information about the status of the EV-Stamp and all associated transactions. The record also contains all the information about the users involved in the process of transactions, their assets, etc. The continuous follow-up of all events in the system of EV-Stamp circulation allows for reliable protection and secured information exchange in the system.

A typical process of communication with EV-Stamp involves three steps: (a) the Sender's record is updated (the EV-Stamp is detached from the Sender); (b) the Receiver's record is updated (the EV-Stamp is attached to the Receiver); (c) the file with the EV-Stamp is transferred from the Sender to the Receiver.

The method of information exchange based on EV-Stamps supports protected and secured communication by using easy-to-recognize visual objects such as stamps in traditional postal services.

2. EV-Stamp: Typical Exemplary Working Scenarios:

Scenario 1. An Internet User Registers at an Internet Site for an EV-Stamp

A connection to a web site associated with the EV-Stamp server is established. An user, Alice, opens the Web-page of the site to register. The site provides all necessary information to open an account. The information can include, but is not limited to, name, address, bank account and/or credit card information, email address, etc. Alice sets her password and establishes a login and password as they are required, while the other data is optional. EV-Stamp client software is downloaded to her computer. Now, she is a registered user who can login to the site and manage one or more EV-Stamps.

Scenario 2. A Registered User, Alice, Obtains an EV-Stamp

Alice, as a registered user, logins in to the site and is presented with a variety of EV-Stamps—graphical images of the postal stamps as illustrated in FIG. 2. The stamps belong to different series or categories of EV-Stamps and have different cash values or functionality and include stamps with no assigned price. She can select and buys one or more EV-Stamps which are then ready for use. The selected/bought items are mounted in her electronic album. The album is managed by the client software downloaded in Scenario 1.

Scenario 3. Alice Sends a Certified Message with an EV-Stamp

Alice would like to send a certified letter to her friend, Bob. Alice decides on what enclosure should be mailed: a letter (arbitrary text), a check, a numbered form, a certificate of a valuable asset, a collection of EV-Stamps, a combination of the above, or in general any information, document or attachment. Alice composes a message using, for example, the EV-Stamp client software downloaded upon registration. Upon completion, the message's enclosure goes into a virtual envelope. Then Alice opens up her EV-Stamp album, selects as many EV-Stamps as needed and mounts the EV-Stamps on the envelope. The EV-Stamps have been registered and stored in a system database and optionally embedded with the sender's digital signature, hash of the letter, etc. Bob's email address (or his pseudonym if it is known to the EV-Stamp server) is put on the envelope. (It is also possible to select the EV-Stamps first and then prepare a text.) The Control information including Sender and Receiver ID's and email addresses, EV-Stamp's ID and other information is encrypted. The message is sent to Bob. Two methods of sending the messages are provided in the client software. The first one uses a standard Mail User Agent such as MS Outlook. In this case, the message with EV-Stamps is sent as an HTML file via a proxy mail server, or a special plug-in software module in the Mail User Agent. In accordance to the second method, the mail is passed directly to the EV-Stamp Internet server. The latter provides better security but may be less appropriate for inexperienced users more familiar with typical email sending routine(s) and applications.

In any case, the transaction is recorded in the EV-Stamp server for verification on receipt by Bob.

Scenario 4. Bob Receives the Certified Message from Alice

Two cases are considered: (a) Bob is new to the EV-Stamp system (he has not registered), and (b) Bob has already registered in the EV-Stamp server.

In case (a), along with the EV-Stamped mail Bob receives an invitation to register in the EV-Stamp site. The registration is carried out as presented in Scenario 1.

In case (b), Bob has the EV-Stamp client software already downloaded. Upon receipt of the EV-Stamped letter, the software is enabled. The EV-Stamps are decrypted, the Control Information is extracted and verified using the EV-Stamp server records. If the EV-Stamps pass the verification process, the message is considered as accepted and appropriate records are formed and updated. For example, if the letter contains the valuable enclosure, Alice records will not keep this asset on her balance sheet any longer while Bob becomes an owner of the transferred asset. The acknowledgement is sent to Alice when the letter is accepted and opened by Bob. The EV-Stamp used as postal stamp (postage) optionally receives an indicia (a postmark) to show that the EV-Stamp has been used.

Scenario 5. Bob Creates and Maintains an EV-Stamp Album and Sells some Items from It

Bob collects EV-Stamps both defaced (e.g., cancelled) and original. He can open the Auction page on the EV-Stamp Web site to trade his stamps. This function of the system covers the needs of EV-Stamp collectors (electronic philatelists). Every time an EV-Stamp is traded, sold or bought, the corresponding records are updated. The uniqueness of an EV-Stamp subject to trade, sell, or purchase is supported due to the encrypted Control Information monitored by the Server. The malicious use, tempering or copying of the EV-Stamps is prevented by using electronic signatures, open and closed keys encrypted in the EV-Stamp and other measures.

The EV-Stamp system supports the production of the high quality EV-Stamp printouts that can be shipped to Bob by his request.

Scenario 6. Alice Transfers Funds Using a Popular Payment System (for example, PayPal®), and Bob Buys and Sells items on eBay® with EV-Stamps

An EV-Stamp can be used in conjunction with any existing Internet service. The EV-Stamp system can come, for example, with a number of plug-ins developed for many popular web sites such as PayPal® and eBay,® or in general any internet web site. The plug-ins based on the EV-Stamp's API can be installed on these Web sites, and, as the result, the sites can show compatibility with the EV-Stamp system.

Alice wants to transfer some funds using a PayPal-type system. She opens the PayPal® site, and clicks on an EV-Stamp icon to automatically login to PayPal® bypassing the standard registration forms. Alice opens her EV-Stamp album, picks an EV-Stamp and drags-and-drops it on the EV-Stamp icon in the PayPal® page. All registration information is encrypted in the EV-Stamp image thus allowing login to PayPal or similar financial systems. This EV-Stamp based method allows one to exclude the dangerous exposure of Alice's sensitive personal information to other Internet users.

Bob uses a similar procedure to buy and sell items on eBay®. It becomes possible with the site supporting EV-Stamp functionality in conjunction with the payment options. This can be accomplished via a plug-in or similar technology. While payment for a good won at an on-line auction is one functionality provided by the EV-Stamp, the EV-Stamp could also be used to verify authenticity, add a degree of legitimacy to the auction due to the inherent security that comes with the registration process used for EV-Stamps, and could verify the seller. All personal information can remain hidden in all internet transactions with financial information encrypted in the transferred EV-Stamp(s).

Scenario 7. Bob Uses EV-Stamps as Electronic Banknotes (E-Money)

Bob decides to use his own method of payment with all who would accept “Bob's” payment method. Bob orders a special graphical image to represent his banknotes. The EV-Stamp system issues a specified number of banknotes covered by the funds deposited by Bob on his EV-Stamp account. As soon as the number of users in the EV-Stamp community reaches a significant critical mass, most trade operations and transactions within the system can be paid by Bob's monies.

In other cases, the EV-Stamps can be designed in the form of bank checks. The EV-Stamp server can be used as a clearance house in inter-banking transactions.

Scenario 8. Alice Runs Her Small Business Using EV-Stamps as Certified and Numbered Forms, Corporate Seals, Power of Attorney Certificates and in General for all Important Business Documents that need Verification

Alice uses different forms and letterheads in her business' accounting system. Some of the forms such as invoices and payment orders must be uniquely identified. Alice orders a specific number of EV-Stamps designed as specified pages with encrypted information that identifies each of the forms uniquely. The forms used in Alice business can now be followed as they move from one person to another by using the encrypted form's ID and Control Information. The corporate electronic correspondence is accompanied with electronic seals as a form of specialized EV-Stamps which are also carrying the concealed information uniquely identifying the corporation and its deeds or other important or verifiable information.

If necessary, the certificates of power of attorney can be issued for electronic documents by using the EV-Stamp server as a notary authority.

Scenario 9. Alice Uses EV-Stamps to Certify Artwork

Alice's business is the dealing of the artwork. Using the EV-Stamp system, she can order graphical images of certificates to be used in dealing the traded pieces of art. Every item can be certified by experts and issued an EV-Stamp as an approved certificate which validity is verifiable by the system. The experts can also have an associated EV-Stamp that could be used in conjunction with Alice's EV-Stamp, thus providing a grouping of EV-Stamps that provide a multi-dimensional aspect to the verifiability of the artwork. The EV-Stamps could be used as a certificate of authenticity as well as to keep track of the production number of the artwork in the case where there are a number of copies, such as signed, numbered lithographs.

Scenario 10. Bob Uses EV-Stamps in Teaching Business Management

Bob is a college professor of economics. He decided to use EV-Stamps in a simulation of business operations. Students in his class play roles of managers in different departments. The results of their business activities are presented as EV-Stamps to model documents, goods and funds. Each transaction is followed by the upgraded records in the EV-Stamp server and in the Control Information placed on the EV-Stamps.

Scenario 11. Alice and Bob Exchange Messages Using Sympathetic EV-Stamps

To make their correspondence completely hidden, Alice and Bob engage in fully secretive correspondence with each other by using EV-Stamps with “sympathetic inks.” In this form of EV-Stamp communication, the whole message or a selected portion thereof is hidden in the EV-Stamp on an additional level that may be separate from the Control Information. The sympathetic EV-Stamps can be used in conjunction with normal correspondence, such as a letter or email, but the message encrypted in the EV-Stamp allows the communication channel to be especially secured.

Scenario 12. Alice Uses Her Album with EV-Stamps as a Source of Entertainment

The EV-Stamp server associates different Internet applications with EV-Stamps of various series. When Alice clicks on an EV-Stamp in her album, a specific application opens up to connect her with games, current news, financial information, etc., or in general any entertainment content. The album can be implemented as a control panel on the active desktop of her PC, or, for example, as an application on a personal entertainment device. The application could be accessed, for example, via an Active Electronic Philately or Philatelistic Entertainment Center icon.

Scenario 13. Bob keeps EV-Stamps on Mobile Devices to Attend Ticketed Events

The EV-Stamp server can be used as a ticket master-like electronic facility. Bob buys EV-Stamps that are used as event passes. Bob transfers the passes bought at the EV-Stamp server to his mobile device. The device's telephone number is registered at the event's ticket booth. So, when Bob goes to the event he sends the EV-Stamped ticket from his mobile device when he shows up at the entrance control. The EV-Stamp is then “redeemed” by the event ticket processing system and reconciled with Bob's EV-Stamp account. Since the EV-Stamp can include graphic content, the ticket-type EV-Stamp could include a picture of the type of event the ticket-type EV-Stamp is for, e.g., a race car for a motor race.

Scenario 14. Alice Pays with EV-Stamps in her Charity Deeds

Alice makes money donations to different charity organizations. The EV-Stamp server makes money transfers to the charity account using EV-Stamps in the form of charity certificates.

Scenario 15. Bob and Alice Receive Periodic Statements as Summary of Their EV-Stamps Activities

Every month, quarter and year (as customized with the EV-Stamp system), Alice and Bob receive the statements where all their operations with EV-Stamps used are reported. The report summarizes financial transactions, the cases of using EV-Stamps for registration, sending the messages, all social, entertainment and other activities. The reports of current activities are also available upon request at any moment.

Scenario 16. Bob Pays for a Measurable Service Using EV-Stamps

Bob uses the EV-Stamp server to store some of his files and other computing resources outside of his computer. The payment for this service provided by the EV-Stamp server is charged based on the volume of stored files and the traffic associated with their use. Bob buys the EV-Stamp used as the “counting meters” to be informed, at any moment, about the remaining balance on the account related to this service.

Scenario 17. Alice Receives Technical Support Using EV-Stamps as Technical Issue Tickets

Alice is not a computer geek. When she needs some technical support for her computer and for a new software package to be installed and correctly used she goes out for a technical support. The EV-Stamp server provides the technical support for its subscribers and supplies them with the technical support EV-Stamps. Alice has subscribed for the service. When she needs some technical help or a new software package to be installed she sends one of the EV-Stamps she acquired along with her subscription to the EV-Stamp Service Center. She accompanies the EV-Stamp with the description of the issue. The EV-Stamp server registers the EV-Stamp with the request and follows up the request processing steps. It is expected that software and PC vendors will find this form of technical support attractive especially to control the copies installed and to prevent their unauthorized use. To make the authorized use of software even more protected, the EV-Stamp server can optionally store images of the hard drives of the subscriber computers and perform maintenance and installation directly on the server, without placing the software copies in user hands.

The above scenarios should be considered only as examples of possible applications of the EV-Stamps in the context of the proposed method of secure communication, identification and certification.

Aspects of the invention thus relate to the use, management, tracking and reporting of EV-Stamps.

Aspects of the invention further relate to a system and technique for authenticating, and tracking information.

Aspects of the invention further relate to a system and technique for money exchange.

Aspects also relate to secure encrypted communication.

Still further aspects relate to utilizing a graphical image in conjunction with control information and encrypted information for communication.

Additional aspects relate to an EV-Stamp having an associated functionality.

Aspects also relate to EV-Stamps for document authentication.

Even further aspects relate to tolls for designing one or more EV-Stamps.

Aspects also relate to EV-Stamp collection.

Aspects further relate to the use of the EV-Stamp as representing a physical object, e.g., a good or service, with the EV-Stamp being exchangeable as a “token” for the good or service.

Since the EV-Stamp could contain a graphical image representing the good or service, the EV-Stamp could be used as a valuable advertising tool.

The present invention can provide a number of advantages depending on the particular configuration. These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media include, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine” , “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The exemplary embodiments of the invention will be described in detail, with reference to the following figures wherein:

FIG. 1 illustrates exemplary types of used EV-Stamps according to this invention.

FIG. 2 illustrates exemplary graphical images of EV-Stamps with indicia (postmarks) according to this invention.

FIG. 3 illustrates an exemplary EV-Stamp client-server architecture according to this invention.

FIG. 4 illustrates an exemplary EV-Stamp client hardware/software configuration according to this invention.

FIG. 5 illustrates an exemplary encryption technique according to this invention.

FIG. 6 illustrates an example of the data base schema implemented on the EV-Stamp server according to this invention.

FIGS. 7-8 illustrate exemplary data flows and processes according to this invention.

FIG. 9 illustrates an exemplary multilayered graphical image according to this invention.

### DETAILED DESCRIPTION

The exemplary embodiments of this invention will be described in relation to EV-Stamps and their associated functionality and related functionality (e.g., electronic certification, identification and communication). However, it should be appreciated, that in general, the systems and methods of this invention will work equally well for any type of communication protocol, document, information, file, electronic or physical file or file format or functionality in any environment.

The exemplary systems and methods of this invention will also be described in relation to EV-Stamp management. However, to avoid unnecessarily obscuring the present invention, the following description omits well-known structures and devices that may be shown in block diagram form, are known or are otherwise summarized.

For purposes of explanation, numerous details are set forth in order to provide a thorough understanding of the present invention. It should be appreciated however that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a telecommunications network and/or the Internet, or within a dedicated secure, unsecured and/or encrypted system. Thus, it should be appreciated that the components of the system can be combined into one or more devices, or collocated on a particular node of a distributed network, such as a communications network. As will be appreciated from the following description, and for reasons of computational efficiency, the components of the system can be arranged at any location within a distributed network without affecting the operation of the system. Similarly, one or more functional portions of the system could be distributed between an EV-Stamp management module and an associated computing device or mobile computing device.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein, are used interchangeably and include any type of methodology, process, operation, mathematical operation or technique.

An exemplary embodiment of the present invention relates to a method for electronic certification, identification and communication by using encrypted graphical images.

The method presents an exemplary technological solution to address at least the issues above in a single integrated way. The approach is based on using encrypted images called EV-Stamps. The method can be embodied in various forms such as:

(1) an electronic equivalent of postal services using electronic stamps;

(2) electronic finance and Internet payment systems;

(3) business letterheads and other official paperwork;

(4) official certificates of all kinds;

(5) a graphical representation of an associated underlying function; and

(6) an exchangeable item correlatable to money.

Functions Associated with EV-Stamps

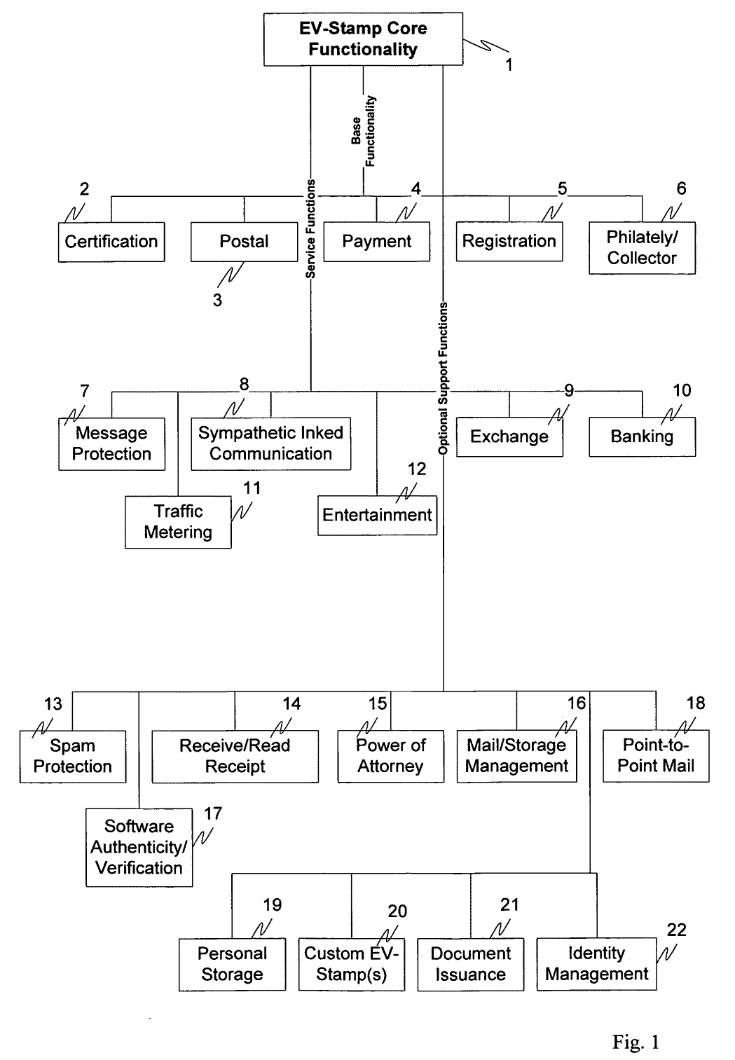

EV-Stamps are one element of the proposed method. Referring to FIG. 1, the following types of EV-Stamps represent the basic functions of the EV-Stamp system.

Core functionality 1—the core functionality is present in every EV-Stamp; it relates to the graphical images, their creation, management, verification and support.

Certification 2—the EV-Stamp is an electronic document capable of certifying the validity and legality of an associated object or Internet action; this function relates to postal, certification, payment and philately functions.

Postal 3—the EV-Stamp that implements this function is an electronic document accompanying an electronic object; Control Information embedded in the postal EV-Stamp contains encrypted data about one or more Senders and one or more Recipients; the EV-Stamp system is capable of tracking an email exchange and helps to resolve any issues concerning the delivery or management of the email. Additionally, the postal function can provide anti-spam capabilities.

Payment 4—the EV-Stamp that implements this function is an electronic document identifying, confirming and representing and reconciling the financial assets registered with the EV-Stamp system. Payment can be made into the system in traditional ways such as by check, credit card or in general by any known method of transferring assets to a destination. When a payment EV-Stamp is sent from one client to another, the rights are transferred for the funds registered with EV-Stamp system. Any EV-Stamp client who uses payment EV-Stamps opens an account with the EV-Stamp system and deposits, withdraws and transfers the funds using the payment EV-Stamps. Each EV-Stamp used in this function can have a face value that represents an amount in an account that can be reassigned or transferred to different clients. This function is derivative of postal, and certification functions, and can also be used with the philately function.

Registration 5—the EV-Stamp that implements this function is an electronic document identifying the EV-Stamp user and representing data used when a Web user registers via, for example, a web-site. This function eliminates the need for the user to fill-in the registration forms and can include information about credit cards, banking accounts, personal information, or in general any information a user would like to have associated with an EV-Stamp. This type of EV-Stamp facilitates the maintenance of the personal data of the EV-Stamp users and also eliminates the chance of the identity theft. Elements of this function can be derived from the certification, postal, and, partially, payment functions.

Philately and collector's auctions 6—in this context, the EV-Stamp can be any EV-Stamp that has been defaced and taken out of circulation by the EV-Stamp system. The EV-Stamp supports EV-Stamp auctions and personal EV-Stamp albums and can at least be used in conjunction with the postal, certification, payment, and registration functions.

Also, there is number of EV-Stamp service functions that can be performed with the EV-Stamp system such as:

Message protection 7—this EV-Stamp function is used to protect the information in a message, such as email, or in general any communication. The message is encrypted with public and private keys, with only the electronic signature of the message being embedded into the EV-Stamp image. The EV-Stamp system, in this case is used as the Certification Center that issues public and private keys for every message to be protected. The public key is stored in the EV-Stamp server and used when Recipient(s) decrypts the message.

Sympathetic inked letter 8—this EV-Stamp function is used when the user wishes, in the case if the letter is intercepted, to mislead about the content of the sent message or to conceal the very fact that a specific message is sent with the email the EV-Stamp is attached to. Only the Recipient is able to discover that the letter was written “with sympathetic inks.”

Exchange (gateway) 9—this EV-Stamp function is used when the user has accounts and/or electronic money wallets in more than one Web-sites performing operations with funds. The EV-Stamp system registers all such accounts (electronic money wallets) and facilitates the exchange (transfer) of funds allocated on different accounts to one or more recipients.

Bank checking 10—this EV-Stamp function is used in conjunction with the user's banking account(s). An EV-Stamp presented having an image of a banking check can facilitate the withdrawal or transfer of funds on a use's associated bank account(s).

Traffic metering 11—this EV-Stamp function is used to measure the changeable resource the EV-Stamp user has an access to (such as the number of used items stored in the EV-Stamp server). In accordance with an exemplary embodiment, the graphical image associated with this EV-Stamp can resembles a dial of a physical measuring device, or a parking meter, with the image optionally being animated with the reading changed corresponding to the changeable resource when a service is performed.

Entertainment 12—this EV-Stamp function is used in the user's album. Each EV-Stamp stored as a personal resource can be activated by clicking on it to perform a function assigned to a specific EV-Stamp series. For example, in a personal computer operating environment, an ActiveX control can be used to open up different windows replacing the original standard image of an EV-Stamp. These windows can be associated with such entertaining applications as computer games, real time news, music, videos, multimedia application, or the like.

Finally, the exemplary EV-Stamp system can provide the following additional and optional support functions:

Protection against spam, viruses, and spyware 13—this function is a natural result of the EV-Stamp technology. The EV-Stamp server can prevent any unauthorized messages to be sent to clients of the system through the verification process.

Acknowledgement on receipt of mail 14—this function comes naturally due to the method of correspondence accepted by the EV-Stamp system.

Power of attorney 15—the EV-Stamp system can perform some authorized operations with the papers submitted by the EV-Stamp client, such as power of attorney. This can be done by comparing the hash functions of the sent and received contents as well as electronic signatures, stored and used to sign the document by the sender.

Bulk mail and storage of big files 16—the EV-Stamp system allocates the storage for big files the user may choose to store on the EV-Stamp server. The EV-Stamp certificates are issued to the user to allow free access to the stored data, with designated EV-Stamp users also being able to use the EV-Stamp system to send bulk mail.

Installation of software packages and technical support 17—the EV-Stamp is issued to a user as a certificate of a technical support agreement between the EV-Stamp client and the system. Protected, and authorized by the vendors, software packages can be installed on the client's personal computers where the client acquires a technical support ticket book issued by the system upon the service agreement. Every time technical support is required, the user sends the ticket with the description of the service.

Point-to-point mail 18—the EV-Stamp system supports point-to-point correspondence between its clients. The EV-Stamp client software installed on the client personal computer establishes a link between two clients as a closed channel via the EV-Stamp server.

Personal mail boxes and safes 19—the EV-Stamp system can allocate storage for different electronic assets the user may choose to store on the EV-Stamp server. Examples of such assets include personal mail boxes and electronic safes, with EV-Stamp certificates capable of being issued to the user to allow free access to the stored assets.

User ordered customized EV-Stamps 20—the EV-Stamp user can order customized EV-Stamp images. These customized EV-Stamps become registered as legal documents on the EV-Stamp system and can be used at the user's discretion.

Issuance of corporate papers and support of corporate activities 21—some of the EV-Stamp functions can be delegated to the subscribed corporations. The customized corporate papers are issued as EV-Stamps and the corporation can use them for accounting purpose, outward mailed documents and others. Document transactions can be monitored by the system through tracking of the EV-Stamp thereby ensuring the uniqueness of each electronic document copy.

Identity management 22—EV-Stamps could be used in conjunction with a request for credit, with the EV-Stamp being required for proof of identity before credit is opened. In that the EV-Stamp is verifiable, this verifiability can be used by a credit issuing agency to ensure the credit requester is who they say they are.

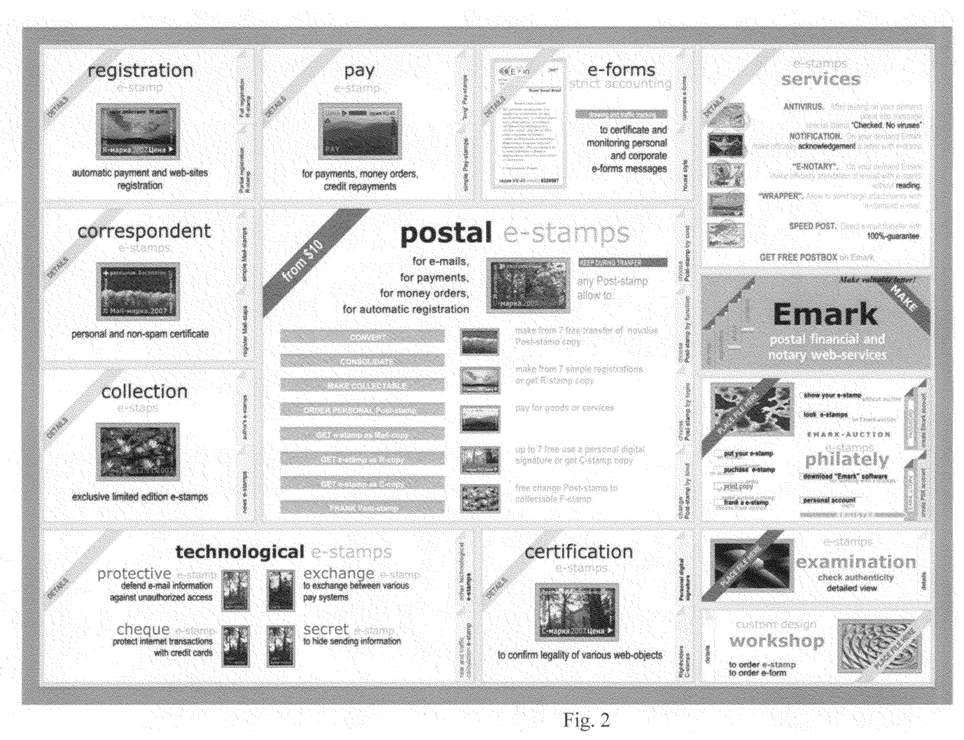

The visual style of EV-Stamps is one exemplary property of the proposed method. Referring to FIG. 2 showing an exemplary user interface, the image of each type of EV-Stamp has a functionally specific graphical image. There are different categories of EV-Stamps including postal stamps, letterheads, corporate papers, notary and other certificates, passes, tickets, etc. A user can select an EV-Stamp function based on the familiar image usually associated with an underlying corresponding function. For instance, all postal EV-Stamps issued by the EV-Stamp system are electronic analogs of the familiar postal stamps. The EV-Stamp system presents the users with different series of stamp images with different face values to choose from. All corporate papers and certificates, banking checks and letters can have images of the corresponding paper documents. All financial and other important documents can be signed with an authentic graphical image of the corporate officer's signature. Each of these images has associated therewith hidden and embedded Control Information identifying and certifying the function, the user and/or other attributes. Some EV-Stamps (especially, in the postal function) can be supplied with postmarks (indicia) similar to what is done by the usual post services. The examples of such indicia are shown on the EV-Stamps in FIG. 2.

Common Types of EV-Stamp Objects

The functions above are performed by exemplary visual and functional object EV-Stamps including but not exclusively limited to the following types:

Mailing EV-Stamp—For certified electronic mail.

Secret EV-Stamp—For encrypting the electronic mail.

Registered mailing EV-Stamp—For confirmation of mailing authorship, and other facts concerning the mailing act.

Parcel EV-Stamp—For sending files of especially large sizes.

Sympathetic EV-Stamp—For hiding a message inside the image.

Passport (registration) EV-Stamp—For storing and sending user's personal information.

Payment EV-Stamp—For paying for services and goods.

Payment and mailing EV-Stamp—For sending a payment via electronic mail.

Contact information EV-Stamp—For sending business card information via electronic mail.

Payment and contact information EV-Stamp—For sending a payment along with business card information via electronic mail.

Rating EV-Stamp—For gathering poll information, rating data, and sending promotional messages.

Certifying EV-Stamp—For authentication of graphical images of documents, files and other objects existing in electronic (digital) form.

Archivist EV-Stamp—For storing and retrieving (by different keys) of the certified documents (files) in archives of EV-Stamp system.

Discount EV-Stamp—For obtaining discounts when purchasing by Internet shopping.

Lottery EV-Stamp—For being used as lottery tickets in internet lottery and drawing of prizes.

Charity EV-Stamp—For making charity and other contributions via Internet.

Personal (customized) EV-Stamp—For being used as a personal customized image ordered by the user.

Greetings EV-Stamp—For sending a greeting and/or funds (used as personal and payment EV-Stamp at the same time).

Collection EV-Stamp—For being used as limited edition EV-Stamp with author's prepared images.

Ticket EV-Stamp—For being used as an electronic analog of a ticket.

Counting EV-Stamp—For being used as an EV-Stamp with varying value to monitor traffic, paid time, etc.

Locking EV-Stamp—For control of access to files and folders.

Widget EV-Stamp—For being used as desktop stamp-windows in which a user can read online news, listen to radio, work with calculators, etc.

Control EV-Stamp—For setting control and monitoring by business managers over employee's use of Internet and other computing resources of the company.

Advertisement EV-Stamp—For posting ads inside the graphics area of EV-Stamps.

Stamped paper EV-Stamp—For being used in business operations as stamped papers (documents).

Reference letter EV-Stamp—For evaluating employees, customers, and business partners.

Event EV-Stamp—For setting and monitoring events.

Article EV-Stamp—For showing a newspaper article.

Password EV-Stamp—For control of access to resources set by an issuer of EV-Stamps which can be sent to designated users.

Bank checking EV-Stamp—For being used in online operations by bank user's accounts.

Physical object EV-Stamp—For presenting certified information about a physical object (consumer goods) along with its graphical image.

Operations with EV-Stamps—Operations with EV-Stamps use the following basic processes. In this example, only positive results of all conditional operations are considered.

Registration and Acquiring EV-Stamps
A user opens the EV-Stamp Web-site to review the possible options concerning EV-Stamps and their utilization
The user is presented with different types and styles of EV-Stamps having different face values or none
If the user is new and decides to register he/she goes through the registration process and the EV-Stamp client software is downloaded to the user's computer
The user opens the local EV-Stamp album in the client EV-Stamp software and selects the EV-Stamps to be bought
The selected EV-Stamps are dragged and dropped onto the album

Sending a Letter with EV-Stamps
The Sender creates a message (letter, EV-Stamps used as blanks, checks, etc.)
The Sender selects an EV-Stamp from the client's album
The client software authorizes the selected EV-Stamp
The Sender issues a command Send (presses a button in the EV-Stamp client software's window)
An envelope's image shows up in the window
The message “flies” into the envelope and sealed
The selected EV-Stamp is attached to the envelope (the postage may require more than one EV-Stamp with the specific face values—in this case, the user can “roll” the EV-Stamps in the same window used a place holder for the postage on the envelope)
The client software calculates or obtains from the EV-Stamp server the encryption parameters (public and private keys, digital signatures and digital certificates) and encrypts the Control Information and the content of the message); in particular, the hash function of the message is calculated and the encryption digest is included in the letter
The client software receives the status information from the EV-Stamp server to indicate the EV-Stamps used to send (the Sent status) and the server's date and time
The client software imposes the Sent status marker on the used EV-Stamps and sends the Recipient address to the server
The EV-Stamp server records the status of the EV-Stamps involved in the process: “sent to the Recipient's address”
The client software sends the letter to the email server of the Recipient

Receiving a Letter with EV-Stamps
The client EV-Stamp software on the Recipient side receives a signal from the email server that a letter with EV-Stamps has been received
The client software carries out the preliminary identification of the EV-Stamps received
The client software sends the EV-Stamps' identifiers, the Recipient's identifier and the address of the Sender to the EV-Stamp server
The EV-Stamp server defines whether these EV-Stamps do exist and relate to the Sender, and were sent to the Recipient
The EV-Stamp server transfers the Sender's public key to the Recipient client software
The client software uses this open key and other encryption and security parameters to extract the encryption digest from the letter's content
The client software calculates the hash function of the letter and compares the calculated digest with the one extracted
The EV-Stamp server “binds” the received EV-Stamps to the Recipient
The client software receives the status information from the EV-Stamp server to indicate the EV-Stamps Received status with the server's date and time
The client software imposes the Received status marker on the EV-Stamps next to the status marker imposed by the Sender
The client software places the letter in the Recipient mail program with a marker “Letter with EV-Stamp”
The client software places the received EV-Stamps in the Recipient album.

Processes Used in Operations with Payment EV-Stamps:

(a) Acquiring a Payment EV-Stamp
Every EV-Stamp holder opens a personal account with the EV-Stamp system and deposit a specific amount of money. The user's personal information including the personal banking accounts to be used for buying and cashing out the payment EV-Stamps is provided at the registration. The deposits on the EV-Stamp account can be performed using

SMS messages;

wire transfer from a banking account;

credit and debit cards;

existing electronic payment systems;

prepaid cards issued by the EV-Stamp system.
On the EV-Stamp site, user selects an EV-Stamp with a face value as needed.
After the EV-Stamp is paid for, a server data base's record is made to relate this EV-Stamp with the user's account.
Also, a user can receive the payment EV-Stamp via regular mail.

(b) Operations with Payment EV-Stamps
Transfer of funds performed via email or electronic transfer (payment EV-Stamps are sent from one user to another).
Buying goods and services on the Web-sites that are under agreement with the EV-Stamp system.

The user performs on-line purchases and sends a specific number of payment EV-Stamps via email to the corresponding Web-site. The Web-site validates the EV-Stamps by connecting to the EV-Stamp server and accepts them as a reimbursement for a purchase. The Web-sites accepting the EV-Stamps can convert them into the funds deposited onto specified banking accounts.

(b) Cashing Out Payment EV-Stamps

performed automatically with one of the following methods:
Transfer to the user's personal banking account.
Transfer to online Web-sites participating in operations with EV-Stamps.
Tracking and reconciliation of the EV-Stamps between the clients holding the EV-Stamps and the server performed as above in all other EV-Stamps functions.

The transaction is considered as completed after the following steps are carried out on the Sender side:
The EV-Stamp server transfers the Received status information with the server's date and time to the Sender's client software
The Sender's client software imposes the Received status marker on the EV-Stamp graphical image next to the Sent status marker earlier imposed by the same client software.

Working with Indicia (Postmarks)

Indicia are used as standalone EV-Stamps representing objects associated with but not necessarily related to issuance of postal EV-Stamps.

An indicium is prepared by the client program using the data received from the EV-Stamp server as the result of successful authorization of a postal EV-Stamp.

Exemplary Algorithm of Usage

Sender writes a letter and mounts a postal EV-Stamp

Upon a Send Letter command, Control Information is prepared by the EV-Stamp server and inserted into the EV-Stamp file

Server returns the EV-Stamp file to the Sender side

In the letter, the postal EV-Stamp is replaced by an EV-Stamp with Control Information received from Server

The letter is sent to its destination

Using transaction data received from Server the client software prepares the indicium image marked as Sent

On the Sender's side, an indicium is imposed on the letter's postal EV-Stamp

Now, the letter is arrived to Recipient

Recipient's client program performs authorization of the postal EV-Stamp

If authorization is successful, Server sends the transaction data to Sender.

Using the received data, Recipient's client program creates an image of the Received indicium

In the received letter, an indicium is imposed on the postal EV-Stamp

The letter is sent to the Recipient's email client where is displayed with the above indicium.

Also, a notification message is sent to the Sender's client program about the letter being delivered to Recipient.

Upon this notification, Sender's client program changes the indicium's text for Delivered and applies it to the sent letter.

Indicia can include encoded:

transaction number

type of cancellation

total number of transactions

date and time of sending and delivery

additional graphical image used for special occasions

The indicia can have various forms, images, color and level of transparency depending on type of cancellation

A user can hide an indicium if necessary. For example, by clicking with mouse the EV-Stamp user can toggle the appearance of the indicium on the postal EV-Stamp.

When indicia are visible on an EV-Stamp and its appearance can be toggled the user is assured that the EV-Stamp is valid.

When the user blows up the EV-Stamp the indicia are blown up also as proportionally scaled images.

Using EV-Stamps to Register on Other Web-Sites

When a user registers on different Web-sites it is important to cut off the attempts by Internet “robots” to login with malicious purposes.

The EV-Stamp system helps to verify that the login is performed by a human.

The following exemplary techniques can be used in conjunction with EV-Stamp functionality:

Basic method—The user transfers to a Web-site an EV-Stamp early obtained. By doing this the user supplies, automatically, the user email and ID as registered at the EV-Stamp system.

Enhanced—Along with email and ID the user can send additional registration data the Web-site may need (such as delivery address, payment terms, etc.) To avoid any risk of massive identity theft as the result of storing personal information of all EV-Stamp clients on the EV-Stamp server it is preferable to store the personal data on the client's computer while only digests (hashes) are to be stored in the server's data base.

Temporary—This registration format is used when users need only to see the content of a Web-site. The site receives from the EV-Stamp server only the confirmation of the user being a client of the EV-Stamp system. No identity information is passed to the Web-site. The access may be granted temporarily.

Anonymous—A Web-site receives an EV-Stamp ID from the EV-Stamp system without sending out any personal information. The site can use this ID to send emails to the user anonymously via the EV-Stamp system.

Closed—A Web-site has two EV-Stamp fields: one for exposing and outputting a special EV-Stamp and the other one for inputting a registration EV-Stamp.

The user can drag and drop an EV-Stamp from the first field to the second one. Simultaneously, the EV-Stamp system authorizes the user, the site's EV-Stamp and performs transactions between User and Web-site. The site's EV-Stamp is received by the user's client program to be placed in the stamp album and to be used as a pass to the Web-site afterwards.

EV-Stamp Architecture

EV-Stamp system comprises the following components:

EV-Stamp core server module

EV-Stamp API (application interface) for use in plug-ins and add-ons to connect to different financial, payment and other external Web sites

EV-Stamp client module

EV-Stamp stamps database

EV-Stamp security layer module

EV-Stamp identification module

The system has two entry points. The first one is used to send queries to the system via EV-Stamp API. The second one can be used to access the system via Web-portal. All external EV-Stamp APIs can interface with the EV-Stamp server via secured socket based interfaces (SSL). Also, the Web server can use SSL for communication with the Web browsers. The basic API module supports communication that can be implemented as an XML protocol supporting the information interchange. Other API modules are connected to the communication module and used to support processing of graphical images, filling in standard forms, etc.

In general, the EV-Stamp system works as follows. The client EV-Stamp software equipped with the API receives a command from a user to perform a transaction in the EV-Stamp system. Using the EV-Stamp API, the client software creates a query and sends it to the EV-Stamp server. The server processing the queries carries out all necessary operations and returns the result of the operations. If necessary, the server generates an event processed by the server processing the events (such as sending the acknowledgement on receipt of an EV-Stamp from a user to unregistered user).

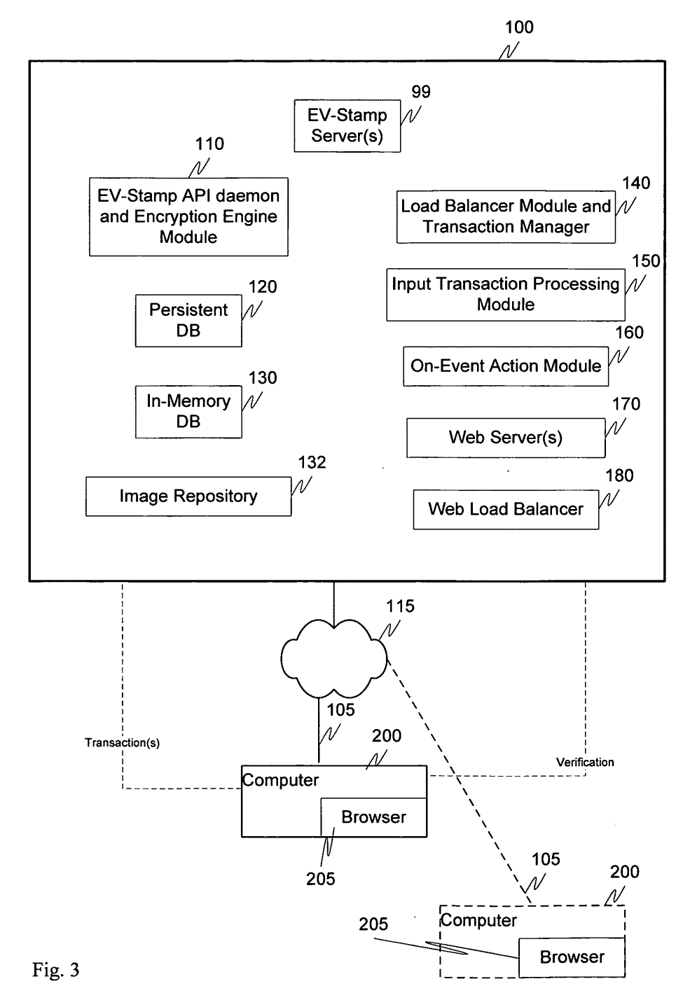

Referring to FIG. 3, the EV-Stamp system 100 provides functionality with one or more computing devices 200, and associated browsers 205, such as external transaction initiation (on an end-user workstation, PC and/or mobile computing device), and in such systems as Paypal®, Ebay®, etc. The system 100 comprises one or more EV-Stamp servers 99, an EV-Stamp API daemon and encryption engine module 110, a persistent database 120, an in-memory database 130, an image repository 132, a load balancer module and transaction management module 140, an input transaction processing module 150, an on-event action module 160 (capable of send e-mails, alarms, notices, transaction statements, etc.), one or more web servers 170 (that at least provide Events browsing, Event actions tuning, Configuration management, user interface management, etc.) and a web load balancer 180.

End-user actions, generally originating from computer 200 and browser 205 generate transactions with the system 100. The functionality of the EV-stamp system supports EV-Stamp transactions and verification protocols.

The core of the system is the EV-Stamp servers 99 which are connected to the EV-Stamp API daemon and encryption engine 110. The management of all transactions related to the databases are performed in cooperation with the load balancer module and transaction manager 140.

The storage is organized as databases including the following parts:

Persistent DB 120 that includes transaction history, configuration, user information, EV-Stamps data base and encryption keys. The in-memory DB 130 includes fast-track access data.

The core of the systems interfaces with user's desktop computer, 200, via user interface associated with web browser 205.

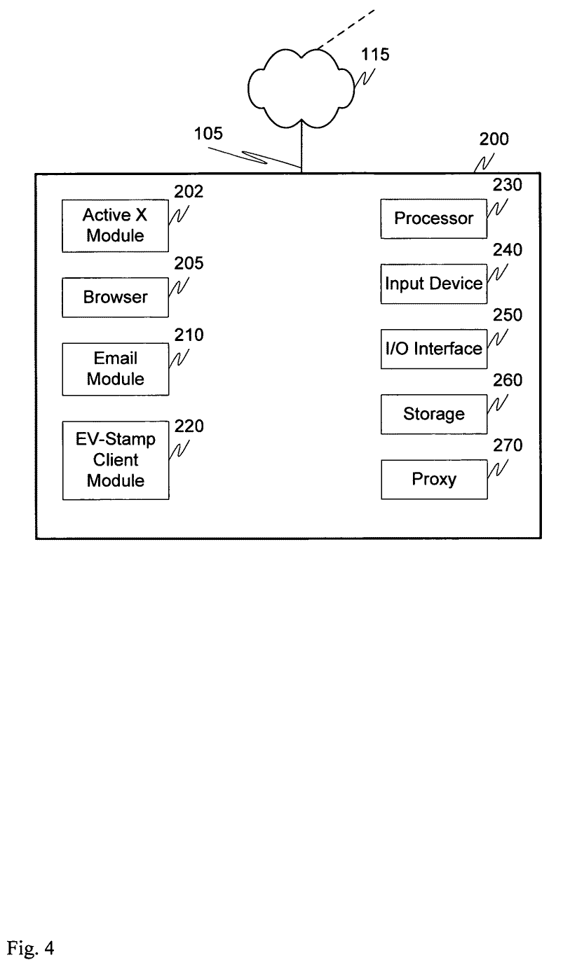

The EV-Stamp client software (running on or in conjunction with computer 200 and browser 205) manages client functionality and introduces it via various EV-Stamp client APIs. An exemplary computer 200 is illustrated in FIG. 4 and comprises an ActiveX module 202, a browser 205, an email module 210, an EV-Stamp client module 220, a processor 230, an input device 240, an I/O interface 250, storage 260 and a proxy 270.

For example, let's consider the standard Microsoft® Windows® environment and the situation when an EV-Stamp is used for a registration function. The Web-site that accepts registration EV-Stamps inserts an ActiveX Object in cooperation with the ActiveX module 202 for the browser 205. This object can be supplied by the EV-Stamp system 100. On the Web-page, this object is presented as a small window with text suggesting to drag-and-drop an EV-Stamp to the window. To register, the user opens the EV-Stamp client software in the EV-Stamp client module and selects a registration EV-Stamp and drags it into the window of the ActiveX Object. As a result, the object calls the EV-Stamp client API's function for decryption in cooperation with processor 230 ad storage 260. After decryption, the Control Information is sent to the server where the user wants to register. This server queries the EV-Stamp server in order to obtain all data needed for registration.

Encryption, Security and Concealing Information Inside the EV-Stamp

In the exemplary method, security is maintained with different means. Important information can be encrypted and stored in the information field of the image file or is embedded in the pixel mask.

An exemplary method of hiding Control Information and the message content associated with EV-Stamps comprises the following steps:

providing digital certificates for all users registered in the EV-Stamp system;

encrypting Control Information and the message content using the digital certificates;

selecting an appropriate EV-Stamp to carry the encrypted information;

storing the encrypted information of a variable size in the information field of a file with the graphic image;

embedding the encrypted information of a fixed size into the image.

The information subject to encryption is, usually, presented in three sections of Control Information:

CI created when the EV-Stamp was issued—unchangeable information;

CI containing the EV-Stamp indicia—changeable information;

user's data to be protected within the image—changeable information.

Each section can include digital signatures and be encrypted. The client software of the EV-Stamp system verifies the digital signature with the following procedure:

the client software contains the digital certificate (such as the X.509 or comparable standard) with the public key for verification of the digital signature. The certificate is the self-signed certificate of the EV-Stamp system or signed by the EV-Stamp master certificate (the latter is used to issue all other certificates used in the system).

on the EV-Stamp receipt, the client software verifies its validity using the following steps:

1. preliminary verification—the digital signature is checked as applied to the content of the message;

2. final verification—current CI of the EV-Stamp is sent to the server for verification.

Various existing algorithms of digital signing can be used such as, for example, RSA, DSA, or ECDSA applied to the hash function of the CI (a standard algorithm of hash function calculation can be used such as SHA1).

Every EV-Stamp user can obtain a digital signature certificate. All user certificates are signed by the master certificate of the EV-Stamp system. As the result, the EV-Stamp client software can always verify the validity of the certificate of the user who has sent the message with the digital signature. All user certificates with public keys are accessible on the EV-Stamp server. The private (secret) key is used only by the sender when signing the message. The digital signature is embedded in a section of the postal EV-Stamp. The same method can be used to verify other objects associated with EV-Stamps.

The method of encryption can be different depending on the required level of confidentiality. The EV-Stamp server 99 can store all the user certificates with public keys. It is important that the EV-Stamp server issues different certificates for digital signature and for the encryption.

To encrypt the sent message of any size, the symmetric algorithm of block encryption, Advanced Encryption Standard (AES) is used with a block being 128 long, and the key 128/192/256 bit long. (This algorithm is the US standard that is open to public use.)

A user who wants to send an encrypted message acquires a public key user certificate from the EV-Stamp server 99. A private key for the symmetric algorithm of encryption, AES, is created on the client side. The message is encrypted with this key. Then the AES key is encrypted with the public key RSA belonging to the recipient and is inserted in the letter being sent. On the receipt of the message, the recipient decrypts, first, the AES key by using the recipient's private RSA key, then decrypts the message itself by using the AES key just extracted. This two-step algorithm is most efficient since

(a) the asymmetric algorithms with open keys are most secured when the length of the encrypted data does not exceed the key's length (in the EV-Stamp system, the AES key is smaller that RSA key);

(b) the symmetric algorithms provide much better security;

(c) all processing steps are performed on the client side, thus requiring less processing time from the EV-Stamp server.

Also, if a user does not want to store the private key on the EV-Stamp server, it is possible for the user to create a certificate on the client side and upload the public key to the EV-Stamp server. In this case, only the user can read the encrypted data.

The encrypted CI and the message content can be inserted into the EV-Stamp with two different approaches. One is based on using the information tags available in some graphic formats. There is no limitation on size of data and, thus, it can be used to insert the message content of the arbitrary size. The second approach uses the insignificant distortion of the pixel mask to embed the data. This approach does limit the size of the data which should be significantly smaller than the image itself. Thus, it can be used for inserting the CI.

The first approach can be applied to any graphic formats having the tags (such as JPEG) while the second one is possible to use only with lossless formats such as PNG.

In JPEG based EV-Stamps, the data stored in a tag is Base64 encoded (it makes the encrypted text look like as ASCII text required by the EXIF standard).

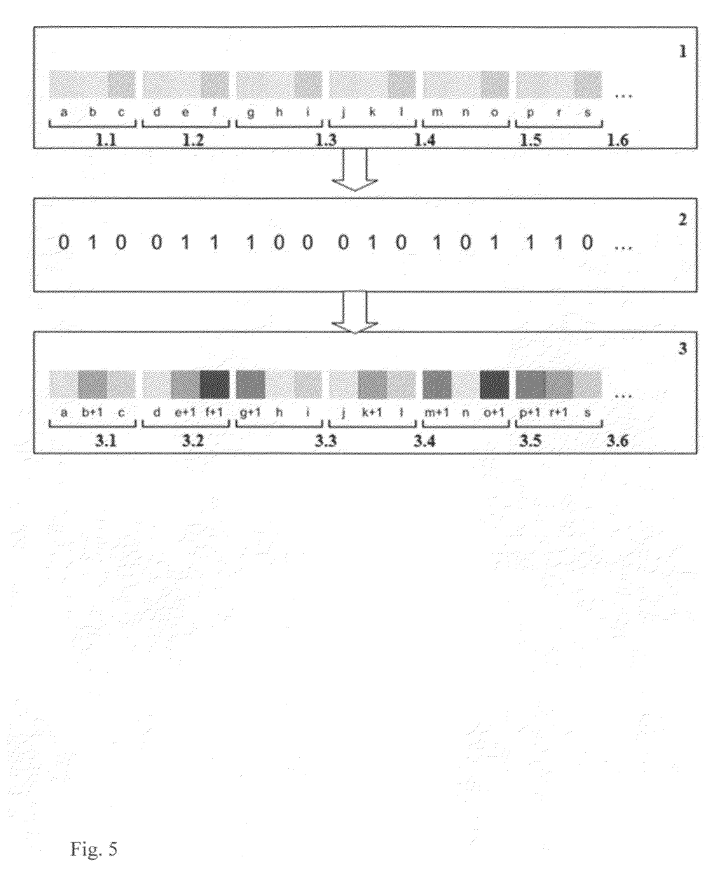

In the non-lossy formats, such as PNG, the CI data can be embedded in the pixel mask. One of the possible ways is illustrated in FIG. 5.

Referring to FIG. 5, a fragment of the original EV-Stamp image 1 has RGB pixels 0 through 5 (3 bytes each), 1.1, 1.2, 1.3, 1.4, 1.5, 1.6. All bytes' last bits are set to 0 (some insignificant loss of image quality can occur). An example of the data to embed, 2, is a string of bits. The last bit of each byte of 1 is changed by setting a corresponding bit from 2. The resulted string of bytes 3 has slightly different string of bytes 3.1, 3.2, 3.3, 3.4, 3.5, 3.6 for pixels 0 through 5.

This method of hiding information is very difficult to uncover provided that the original pixel mask is not available.

Database Schema

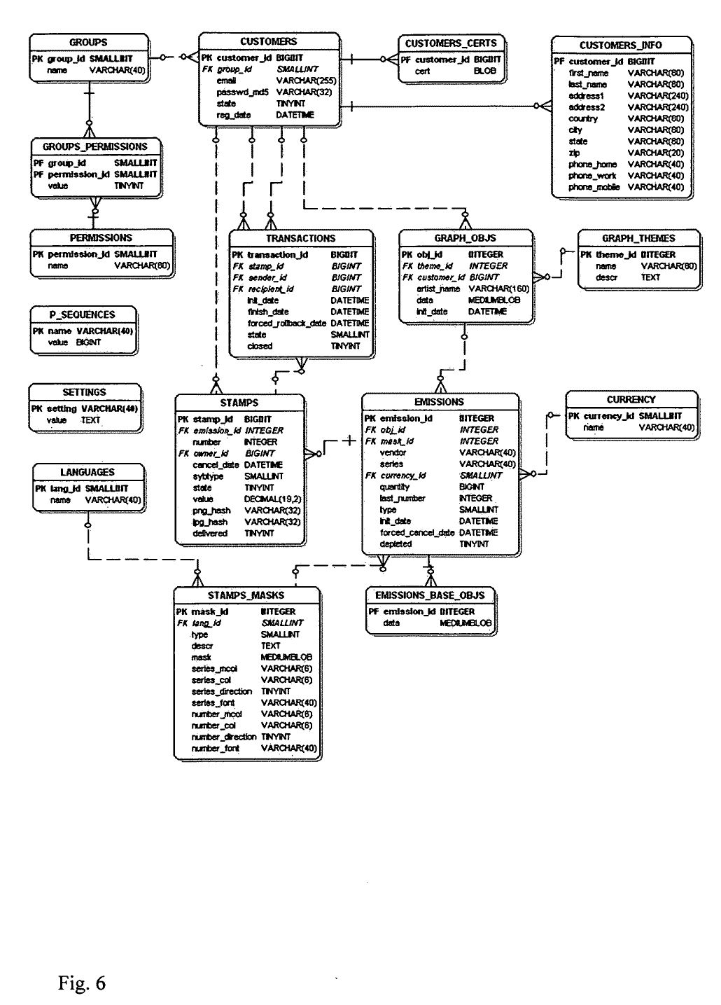

In an exemplary embodiment of the proposed method, and as illustrated in FIG. 6, all information used in the EV-Stamp system is presented in the relational database comprising relations (tables) with attributes (records) of objects the relations represent. The links between the relations are used by the EV-Stamp database engine to perform all operations with EV-Stamps.

Specifically in relation to FIG. 6, the following tables can be used in a typical EV-Stamp database schema: Groups (of customers), Customers, Customer Certificates, Customer Information, Groups Permissions, Permissions, Transactions, Graphical Object, Graphical Themes, Settings, Stamps, Emissions, Currency, Languages, Stamp Masks, etc.

The data stored in the database are used, for example, to create Control Information inserted in an EV-Stamp, such as: EV-Stamp vendor, EV-Stamp series, encryption digest of EV-Stamp image, artist (creator of EV-Stamp), theme, date of creation, number of issued EV-Stamps, expiration data, unique ID, EV-Stamp number in the series, date of emission, etc.

After a user has obtained an EV-Stamp from the EV-Stamp server or via email or in any other legal way, the EV-Stamp as a graphical file can be saved on a removable media (such as CD/DVD, USB flash memory, etc.) to manually or electronically transfer it as a file to any other (different) user's collection of EV-Stamps on any other (different) target computer even if the target computer is off-line.

If the client software has already been installed on that computer the client software validates this graphical file only as an EV-Stamp. Complete validation including the EV-Stamp's record can be deferred until the online connection becomes available. The EV-Stamp is stored on the target computer as partially validated. It is displayed in the collection of EV-Stamps in a different way to indicate its status. It can't be used in its capacity (as a postal, registration, or others) until the computer gets online. (For mobile devices in the context of working off-line.)

After the target computer is online the client software connects to the EV-Stamp server to synchronize the EV-Stamps collection on the target computer with the records in the EV-Stamp server's data base. As the result, the EV-Stamp that was added offline becomes validated if it was obtained as the result of a legal transaction. The status of the deferred validation is replaced with status Available and the EV-Stamp can be used as its function permits.

An EV-Stamp can be used to represent a physical object (e.g., a token) by providing an electronic and printable image. The image in electronic form of an EV-Stamp carries unique information concerning the object it represents. The information can include the physical object's ID, its manufacturer, or designer, its price, the owner, etc. EV-Stamps can be used as certificates of validity of physical artifacts where the EV-Stamp server is used to certify and validate, for example, piece of art.

Another application of the EV-Stamps as physical object's representations is trade and retail. Any retail item can be advertised by using the EV-Stamps with images of the trade/retail object carrying the encrypted information concerning its value/price, ID and status. The EV-Stamps in this case are used as coupons that can be traded for the corresponding goods or services. The Points of Sale or Internet sale Web-sites connect to the EV-Stamp server to obtain the status of the coupon and verify its validity, with account reconciliation occurring when the token (EV-Stamp) is exchanged for the good/service.

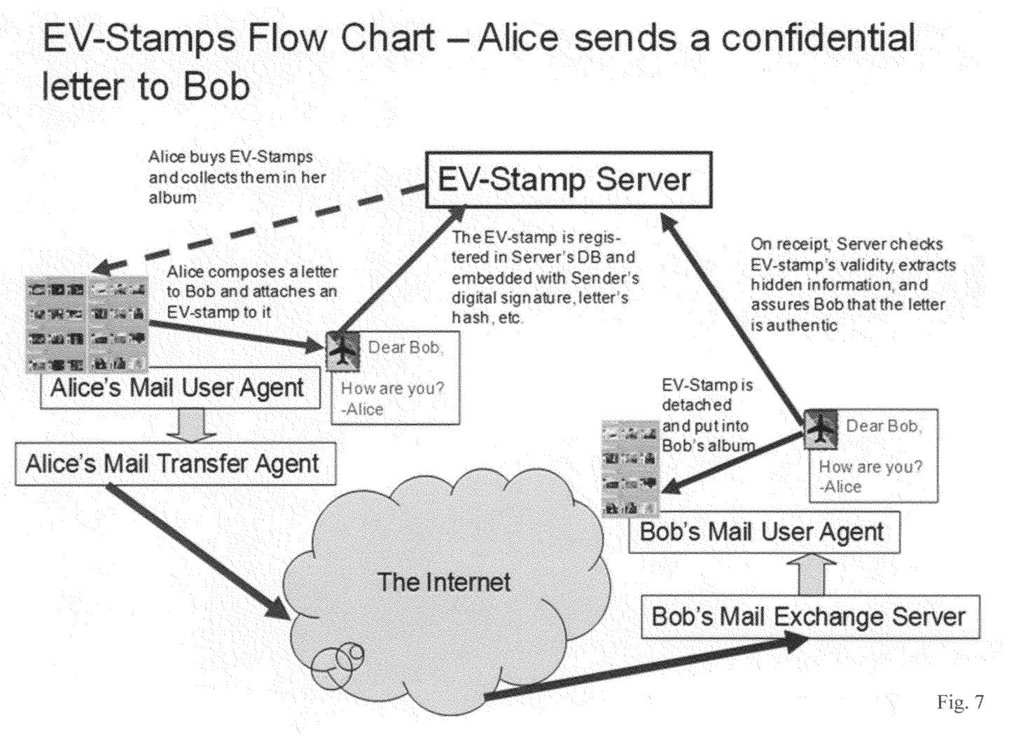

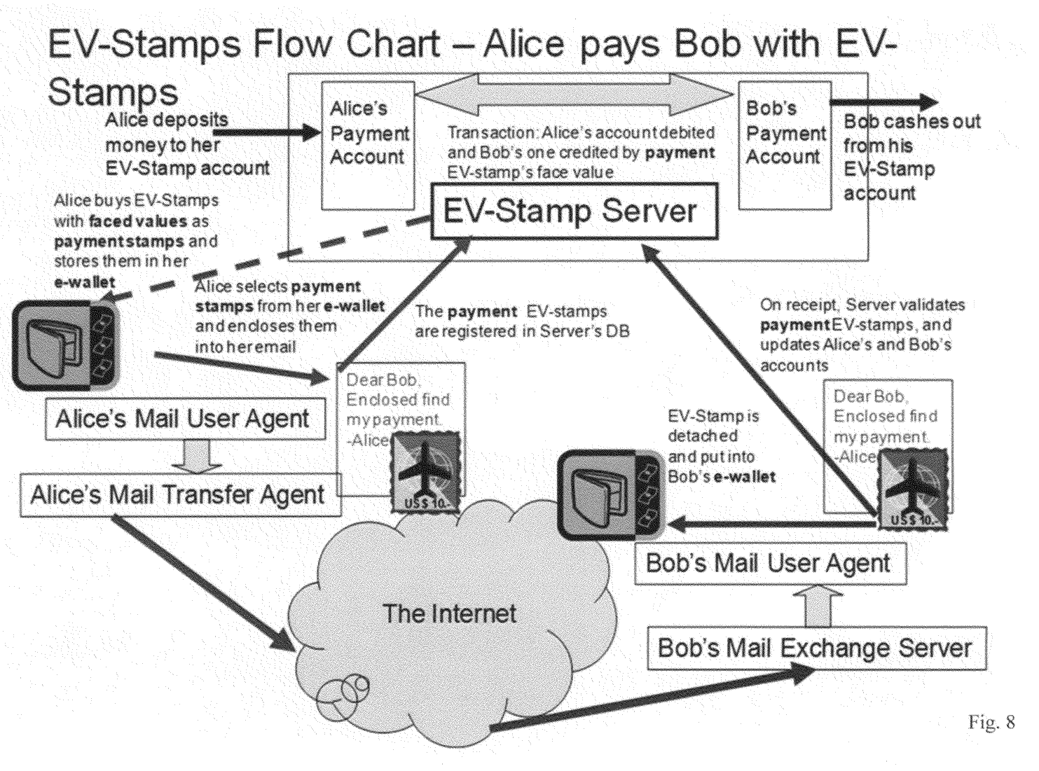

FIGS. 7-8 illustrate graphically the data flow and operations associated with two exemplary EV-Stamp transactions. Specifically, FIG. 7 illustrates an exemplary flow for Alice sending a confidential letter to Bob, with the flow commencing with Alice buying one or more EV-Stamps that are stored in her album. FIG. 8 illustrates the flow of Alice paying Bob with an EV-Stamp, with the various functionalities outlined commencing with Alice establishing and depositing money in Alice's payment account.

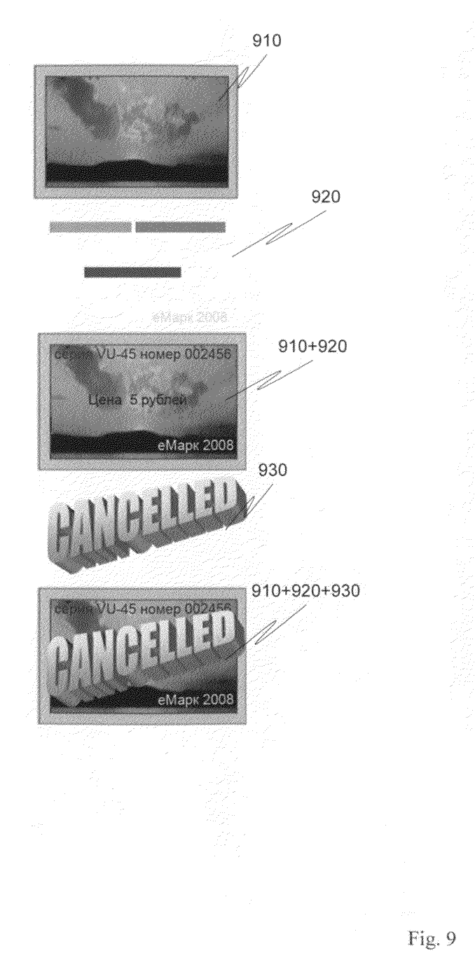

In an additional embodiment shown in FIG. 9, the EV-Stamp can be comprised of a multilayer graphical image. A base layer 910 may be an image of a postal stamp. This object has such attributes as theme, name of artist, date of entry, etc. The second layer 920 represents the graphical information characterizing the EV-Stamps that can be derived from the base layer image. The information includes description, face value (if any), typographical information about the overlaying text, standard sizes, etc. The background of this layer is transparent. The third layer 930 is used for indicia such as SENT, RECEIVED, CANCELED.

The process of creating the EV-Stamps repository stored in the EV-Stamp server starts with creating a pool of image files used as the base layer. The next phase is issuance (emission) of specified number of EV-Stamps of specific series, face values, sizes and attached functionality. In all processes associated with EV-stamps circulation, the third layer may be attached. All phases are monitored and tracked by the server.

In another exemplary embodiment, steganography, transfers of “secret” data are possible without arousing suspicion that the data is present. EV-Stamps are used to carry the message across to the receiver. Unique ID, digital certificates, classified information are encrypted inside the stamp without ever being detected by attackers or third parties. Once it reaches its destination, the receiver decrypts the message from the stamp and allows it to be shown.

In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, network(s) and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated system, system component, or the like. The system can also be implemented by physically incorporating the system and/or method into a software and/or hardware system.

Although the present invention describes components and functions implemented in the embodiments with reference to particular standards and protocols, such as the encryption algorithms, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate exemplary embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method of electronic certification, identification and communication through the use of encrypted graphic images comprising:
issuing one or more graphical images to a registered user;
encrypting user specific information in the one or more images;
encrypting a user's message; and
securing correspondence between different users by associating the one or more graphical images with the correspondence, the one or more graphical images used by a client associated with the second user to validate one or more of certification, identification and the correspondence.

2. The method of claim 1, further comprising transferring one or more of financial assets and document authentication information with the one or more images.

3. The method of claim 1, wherein the one or more graphical images are one or more of an electronic postal stamp, a financial document, corporate papers and a certifiable document.

4. The method of claim 1, further comprising providing the encrypted graphic images with an underlying functionality including one or more of spam protection, receive or read receipt, software authentication, power of attorney, mail management, document issuance, identity management and point-to-point mail.

5. The method of claim 1, further comprising stacking multiple encrypted graphic images, with each of the stacked encrypted graphic images including an underlying associated functionality.

6. The method of claim 1, further comprising validating one or more functions associated with the encrypted graphic images against information stored in an EV-Stamp server.

7. The method of claim 1, further including maintaining an account that stores the one of more encrypted graphic images.

8. The method of claim 1, wherein at least a portion of the encrypted content in the one or more encrypted graphic images is not visible to the human eye.

9. The method of claim 1, wherein the one or more encrypted graphic images are tracked through a network between a source and a destination.

10. The method of claim 1, wherein the one or more encrypted graphic images include an image corresponding to the underlying functionality associated with the encrypted graphic image.

11. A system for electronic certification, identification and communication through the use of encrypted graphic images comprising:
an EV-Stamp server adapted to issue one or more graphical images to a registered user; and
an EV-Stamp API daemon and encryption engine module adapted to encrypt user specific information in the one or more images and user information, wherein the one or more encrypted graphic images are used to secure communications between different users by associating the one or more graphical images with correspondence, the one or more graphical images used by a client associated with the second user to validate one or more of certification, identification and the correspondence.

12. The system of claim 11, wherein one or more of financial assets and document authentication information are associated with the one or more images.

13. The system of claim 11, wherein the one or more graphical images are one or more of an electronic postal stamp, a financial document, corporate papers and a certifiable document.

14. The system of claim 11, wherein the encrypted graphic images are associated with an underlying functionality including one or more of spam protection, receive or read receipt, software authentication, power of attorney, mail management, document issuance, identity management and point-to-point mail.

15. The system of claim 11, wherein stacked multiple encrypted graphic images provide a plurality of functions.

16. The system of claim 11, wherein the EV-Stamp server is further adapted to validate one or more functions associated with the encrypted graphic images against information stored in the system.

17. The system of claim 11, further including one or more databases adapted to maintain account information and the one of more encrypted graphic images.

18. The system of claim 11, wherein at least a portion of the encrypted content in the one or more encrypted graphic images is not visible to the human eye.

19. The system of claim 11, wherein the one or more encrypted graphic images are tracked through a network between a source and a destination.

20. A method of electronic certification, identification and communication by using encrypted graphic images in EV-Stamps, financial documents, corporate papers and similar familiar and useful objects universally accepted in different forms of human activities, comprising:
associating a graphical image with an embedded security certificate;
issuing said graphical images on a designated web portal;
providing the means to acquire said graphical images by a registered internet user;
encrypting user specific information in said images;
encrypting a user's messages with said images;
securing correspondence between different users when said images are made part of the communication; and
providing the means for transferring financial and other assets between the users when said images are used.

21. Means for performing the functionality of claim 1.

22. Information storage media including computer executable instructions stored thereon that, when executed, perform the functionality of claim 1.

23. A method of electronic communication using encrypted graphic images comprising:
providing a certified container, wherein the certification of the container is verifiable by one or more encrypted graphical images; and
transmitting information using the certified container, the information capable of including one or more additional encrypted graphical images.
